(19) United States
(12) Patent Application Publication
(10) Pub. No.: US 2010/0270284 A1
(43) Pub. Date: Oct. 28, 2010

(54) Kettle and Base

(75) Inventors: Paul Cohen, New South Wales (AU); Vyvyan Rose, New South Wales (AU); Nicholas Edmonds, New South Wales (AU)

Correspondence Address: MICHAEL MOLINS;MOLINS & CO., SUITE 5, LEVEL 6, 139 MACQUARIE ST, SYDNEY NSW, 2000, AU

(73) Assignee: Breville Pty Limited, Botany (AU)

(21) Appl. No.: 12/809,602

(22) PCT Filed: Jun. 26, 2009
(86) PCT No.: PCT/AU2009/000828

§ 371 Date: Jun. 24, 2010

(30) Foreign Application Priority Data
Jun. 26, 2008 (AU) 2008903249

(51) Int. Cl. A47J 27/00

(52) U.S. Cl. 219/429; 219/507

(57) ABSTRACT

A kettle or other appliance that generates water vapour or steam has a hinged, transparent lid. The lid has two lenses, being an upper lens and a lower lens.

### FIELD OF THE INVENTION

The invention pertains to cordless kettles and more particularly to a cordless kettle with various temperature settings and other enhancements.

### BACKGROUND OF THE INVENTION

A conventional electric kettle, once activated by a user, will boil its contents and then cease operation. However, the growing popularity of tea brewing and sophistication of its Western consumers indicates a need for a kettle that is adapted to deliver water at a variety of distinct temperatures, including boiling.

The western tea drinking consumer is also desirous of acquiring a kitchen appliance with enhanced aesthetic and performance features.

Data communication between the base and cordless kettle are disclosed in the applicant's co-pending PCT Application No. PCT/AU2008/000724 incorporated here by reference. Construction of a kettle with lid damper is disclosed in the applicant's Australian Provisional Application No. 2004902070, incorporated here by reference.

The present invention provides improvements that contribute to the aesthetic, ergonomic and functional attributes of a kettle or other device that generates hot water or steam.

### OBJECTS AND SUMMARY OF THE INVENTION

In one embodiment of the invention, a kettle further comprises a lid having inner and outer lenses between which is void.

In some preferred embodiments of the invention, the kettle further comprises a heating element having a pair of cold pins. An LED light that is used to illuminate the interior of the kettle is located adjacent to the cold pins.

There is also provided, a combination of cordless kettle and base, the base having within it a processor for responding to information originating from the kettle, the processor adapted to respond to user inputs and to effect power control over the kettle. The base has a plurality of discrete temperature selection control switches and an on-off switch, an input from a temperature control switch and then subsequently the on-off switch being required to cause the power to be supplied to effect power control over the kettle.

### BRIEF DESCRIPTION OF THE DRAWING FIGURES

In order that the invention be better understood, reference is now made to the following drawing figures in which:

FIG. 1 is a perspective view of a cordless kettle and base in accordance with the teachings of the present invention;

FIG. 2 is a plan view of kettle base and control;

FIG. 3 is a perspective view of underside of kettle lid;

FIG. 4 is a cross section view of kettle lid;

FIG. 5 is a perspective view of kettle vessel showing filter in situation;

FIG. 6 is a perspective view of pour filter;

FIG. 7 is an underside view of kettle base and element; and

FIG. 8 is a cross section view of a vessel body.

### BEST MODE AND OTHER EMBODIMENTS

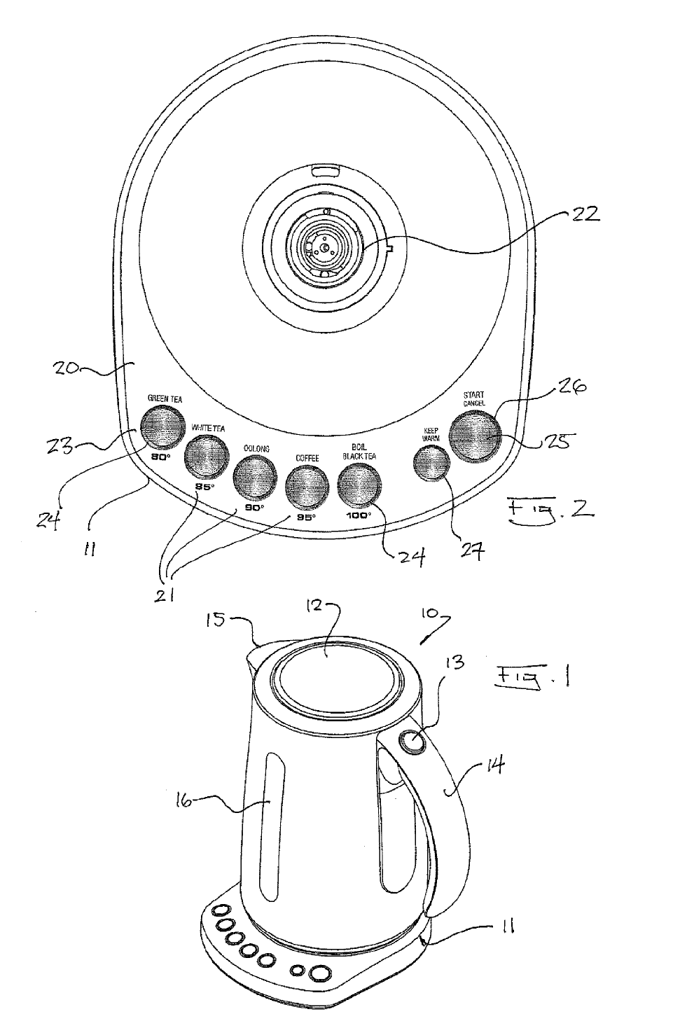

As shown in FIG. 1, a cordless kettle 10 has a base 11. The base 11 is connectable to a mains power outlet and operates, when the kettle and base are attached to one another, to control the operation of the kettle and provide the user with convenient controls and feedback concerning the operation of the kettle. Data communication between the base and cordless kettle are disclosed in the applicant's co-pending PCT Application No. PCT/AU2008/000724 incorporated here by reference. Construction of a kettle with lid damper is disclosed in the applicant's Australian Provisional Application No. 2004902070, incorporated here by reference.

In the example of FIG. 1, the kettle 10 further comprises a hinged and transparent lid 12 that is operated by a thumb button 13 located on an upper extent of the kettle's handle 14. The kettle has a pouring spout 15 and a transparent view window 16. As will be explained, the interior of the kettle is illuminated and light (such as coloured light) is visible both through the view window 16 and the transparent lid 12.

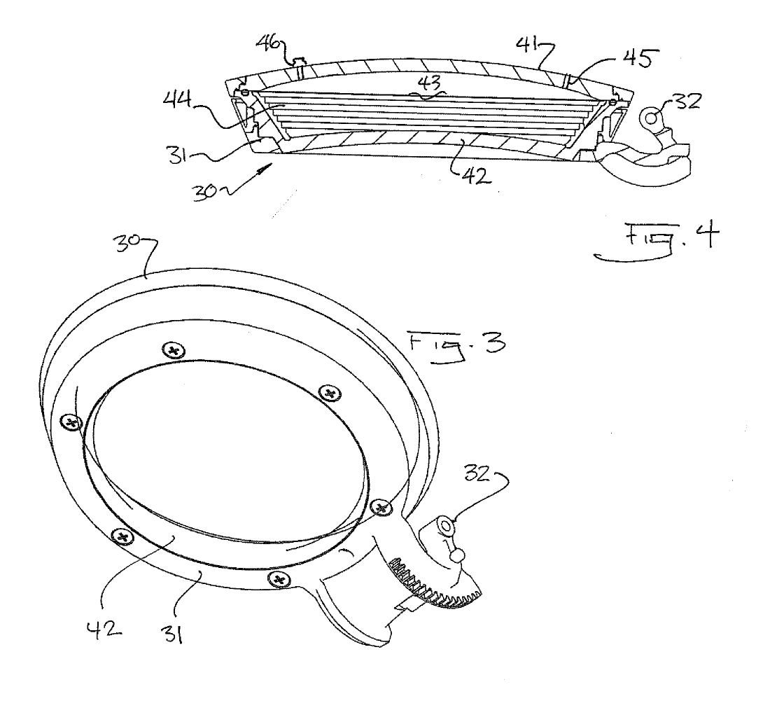

As shown in FIG. 2, an upper surface 20 of the base 11 presents the user with a variety of buttons, switches or controls 21. A multi-pole electrical coupling 22 connects with a cooperating coupling located on an underside of the kettle 10. The coupling 22 transmits power and optionally, control signals to the kettle and may optionally receive data communication signals from the kettle, for example regarding the temperature of the water in the kettle. In this example, the temperature related user controls are five in number. Each control in this example comprises a button that is surrounded by a selectively illuminated ring 24. Any other visual indicator or display may be used in place of the illuminated ring 24. From left to right with respect to FIG. 2, a first user control 23 is marked e.g. “green tea” and corresponds with a final water temperature of 80 degrees Celsius (“□C”). A second user control is marked “white tea” and is also marked with a final water temperature of 85□C. A third button is marked “oolong” and is marked with a final water temperature of 90□C. A fourth user control is marked “coffee” and with a final water temperature of 95□C. A fifth user control is marked “boil/black tea” and is marked with a final water temperature of 100□C. Selection or activation of any of the aforementioned temperature controls will cause the device's processor to select a water heating cycle. In addition to the five temperature controls, the base is also provided with a start/cancel control 25. The start/cancel control also has an illuminated ring 26 or other graphic indicator.

As previously mentioned, the heating cycle begins with a user selection that is first input through the temperature controls 24. Subsequent depression of the start/cancel control 25 results in power being supplied to the kettle's heating coil and a simultaneous illumination of the indicator ring 26 (or other graphic indicator) associated with the start/cancel control 25. After a use of the start/cancel control 25, the water in the kettle will be heated to the user selected temperature whereupon the kettle's thermostatic control will provide feedback that causes a disabling of the kettle's heating element. This may be done, for example, by having the kettle's internal thermostat in communication with a processor located in the base 11. A subsequent user activation of the start/cancel control 25 during a heating cycle will cause the cycle to be terminated. Ergonomically, it is preferred that the inception and the cancellation of a heating cycle be conducted from the same user control 25 rather than, for example, having the user input a cancellation through one of the five individual temperature control buttons 28. In addition to the aforementioned controls, the base of the kettle also provides a “keep warm” button 27 that, if used during a heating cycle, will cause the device's processor to cooperate with the power supply and heating element to maintain the water in the kettle at either the last selected temperature for a set time, such as 20 minutes.

In preferred embodiments, the illuminated ring 26 or other graphic indicator associated with the start/cancel button 25 preferably changes colour so that it is a different colour (such as red) during a heating cycle that at any other time, a green ring 26 indicating that the unit is plugged in. This provides additional feedback to the user regarding which button to press when a cancellation of a cycle is required. In preferred embodiments, the rings 24 of the temperature selection controls are not illuminated until a selection has been made. Thus, the user knows what temperature has been selected because only that button's ring 24 or indicator is illuminated. It is also preferred that a user can re-select or change the final water temperature without use of the start/cancel control 25, simply by operating a different temperature control 23 to the one previously selected. In selected embodiments, the device will default to the last temperature selected so that if a particular temperature is regularly used, the user or operator need only activate the start/cancel control 25. When this is done, the last selected temperature will be indicated by the illumination of its ring 24 or other graphic indicator. The illumination ring 24 or other graphic indicator associated with a temperature selection control 23 may flash to indicate that the kettle is in a heating cycle. When the selected temperature is reached, the illumination ring 24 or other graphic device associated with a temperature control 23 is lit continuously (not flashing). The appropriate illumination ring 24 or other graphic device will stay in this continuous illumination mode for a predetermined amount of time, for example, one minute.

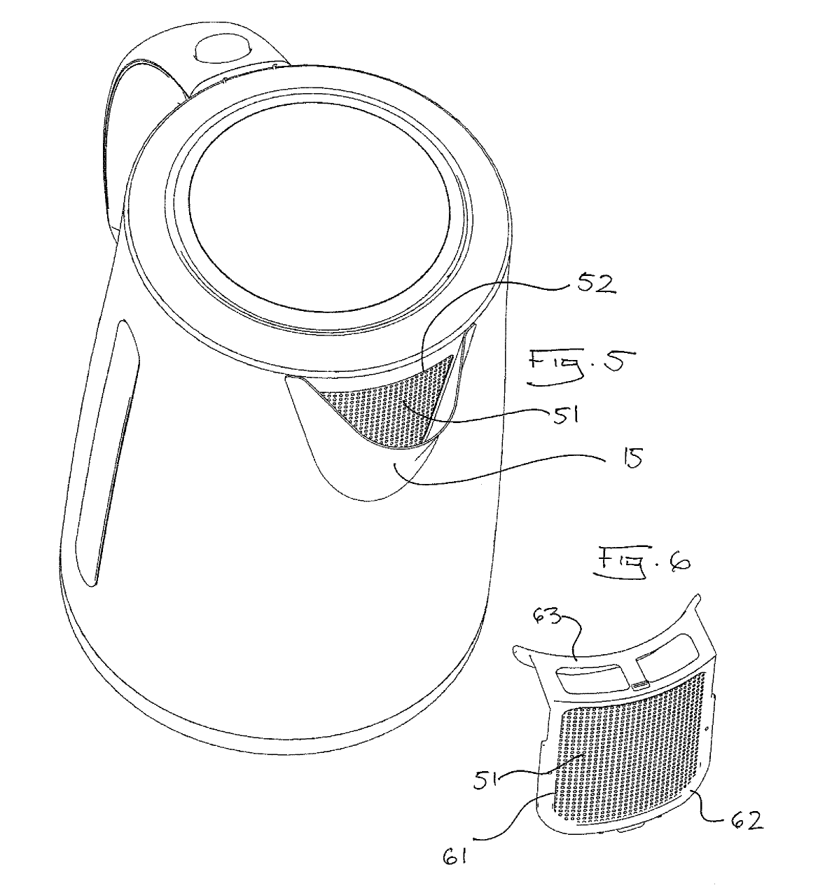

As shown in FIG. 3, the kettle's lid 30 comprises an annular or ring-shaped frame 31 having a hinge component 32 for attaching the lid to the kettle's body. As shown in FIG. 4, the lid 30 is characterised by an upper lens 41 and a lower lens 42. This provides a large clear window that is cool to the touch. In this example, the lenses are lightly tinted and curved or domed away from the interior of the kettle. The curvature of the upper and lower lenses is similar. The upper lens 41 is generally flush with the surrounding portion of the frame 30. To combat condensation, the upper lens may be provided with a small vent 45 or one-way or check valve 46 leading into the interior space 43. The vent 45 is preferably small enough that capillary forces resist the inflow of liquids into the interior space 43. The lower lens 42 may also be flush with the lower surface of the frame 31. In preferred embodiments, the void or interior space 43 between the upper and lower lenses 41, 42 may be filled with an inert gas or dehumidified air so that the interior may be kept dry and free from condensation. In the example depicted in FIG. 4, the internal periphery of the void 43 further comprises a ring-like liner 44. The inside surface of the liner 44 is formed as a series of concentric, ascending steps. Light reflecting from the individual steps creates an aesthetically pleasing illusion of depth and serves as a means of indicating that the device is plugged in, by better reflecting the kettle's internal illumination through the upper lens 41.

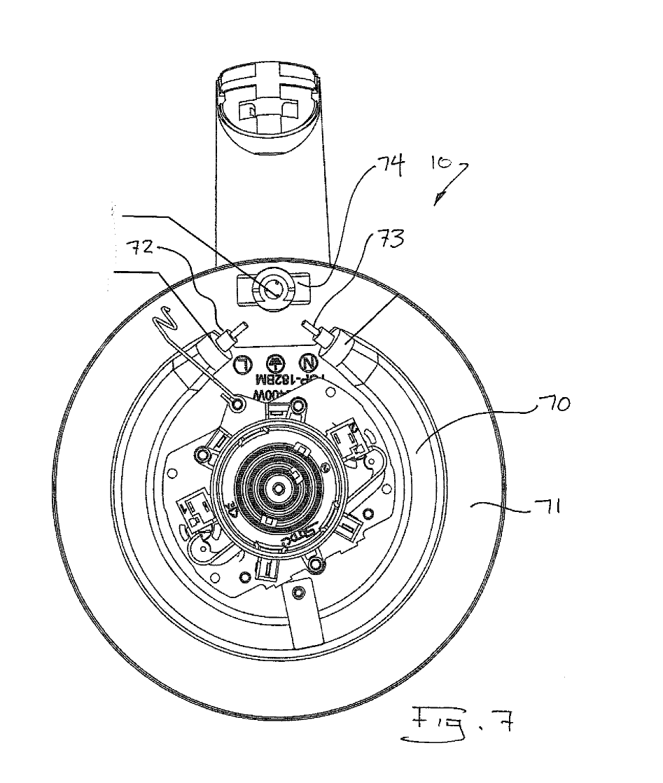

As shown in FIG. 5, water being poured through the kettle's spout 15 first passes through a pour filter 51. As with prior art pour filter's, the filter covers, from the inside of the kettle, the entirety of the pour opening 52. However, unlike other electric full size kettles the pour screen 51 is not blocked or occluded by the conventional kind of bracing that is used to support the pour filter. As shown in FIG. 6, the pour filter 51 is continuous and unobstructed and supported only about its periphery 61 by a moulded polymeric frame 62 having no cross pieces or bracing that would obstruct the pour opening 52. In preferred embodiments, the pour filter 51 is a thin perforated metal screen. The polymeric frame 62 may include a finger grip portion 63 that extends away from the filter 51, making it easier for the user to remove and reinsert the filter, as required. Thus, the filter 51 is considered unobstructed.

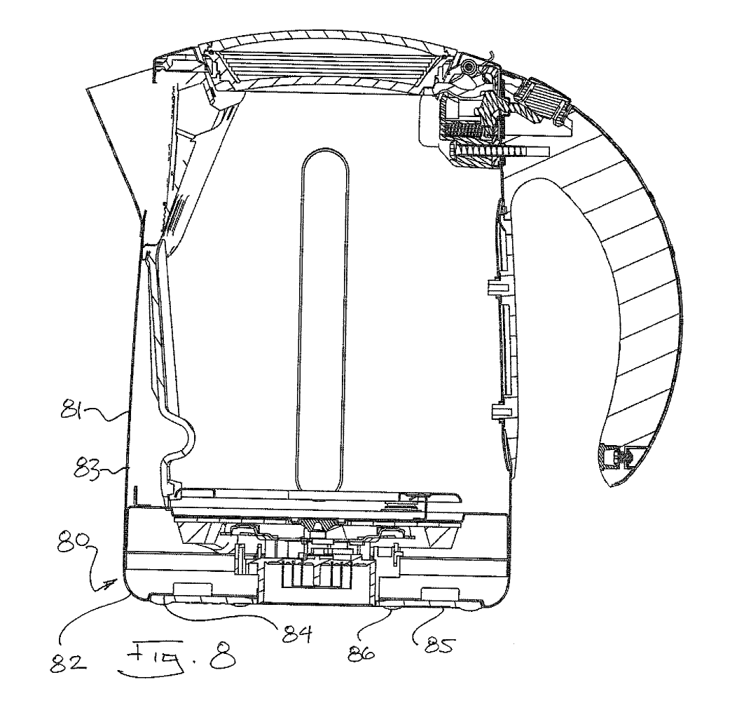

As show in FIG. 7, a heating element 70 is located adjacent to the floor 71 of the internal fluid compartment of the kettle to. The bare ends of the heating element 70 comprise cold pins 72, 73. The cold pins are the least hot portions of the element 70. The floor 71 also supports an LED illuminator 74 that is able to transmit light into the reservoir or internal compartment of the kettle through a transparent (or translucent) cover. To minimise heat damage and degradation to the LED illuminator 74, it is located adjacent to the cold pins 72, 73 and preferably equally spaced from each of the cold pins 72, 73.

As shown in FIG. 8, the lower extremity 80 of the one piece metallic kettle body 81 is strengthened by providing a continuous and smoothly radiused corner 82 that extends between the side wall 83 of the kettle body and a generally flat underside 84. The radiused continuity between the side wall 83 and the underside 84 can be achieved, for example, by roll forming the body's metal structure in the area of the lower extremity 80. In preferred embodiments, the underside 84 is stepped to receive a polymeric disk-like insert 85 that incorporates the feet 86 upon which the kettle rests.

While the present invention has been disclosed with reference to particular details of construction, these should be understood as having been provided by way of example and not as limitations to the scope or spirit of the invention.

What is claimed is:

1-26. (canceled)

27. A device for heating a liquid that it contains, being a combination of cordless kettle and base, the base having within it a power supply and a processor for responding to information originating from the kettle, the processor adapted to respond to user inputs and to effect power control over the kettle, wherein:
the base has a plurality of discrete temperature selection control switches and an on-off switch, an input from a temperature control switch and then subsequently the on-off switch being required to cause the power to be supplied to a heating element in the kettle.

28. The device of claim 27, wherein:
a multi-pole electrical coupling connects with a cooperating coupling located on an underside of the kettle, and the coupling transmits power to the kettle and receives data communication signals from the kettle regarding the temperature of a liquid in the kettle.

29. The device of claim 27, wherein:
each discrete temperature selection control switch being associated with an illuminated indicator that indicates that a switch has been selected.

30. The device of claim 27, wherein:
a subsequent user selection of the on-off switch during a heating cycle will cause the cycle to be terminated.

31. The device of claim 27, wherein:
the base of the kettle also provides a “keep warm” switch that, if used during a heating cycle, will cause the device's processor to cooperate with the power supply and the heating element to maintain the water in the kettle at a last selected temperature.

32. The device of claim 27, wherein:
an indicator associated with the on-off switch changes appearance so that it is a different appearance during a heating cycle than at any other time, thus providing feedback regarding which button to press when a cancellation of a cycle is required.

33. The device of claim 28, wherein:
the microprocessor will default to a last temperature selected, the last selected temperature being indicated by the illumination of the indicator, that indicator flashing to indicate that the kettle is in a heating cycle and when a selected temperature is reached, that indicator is illuminated continuously.

34. The device of claim 29, wherein:
a discrete temperature selection control switch will indicate that it has been selected when a new temperature selection is made by a user during a previously selected heating cycle.

35. The device of claim 34, wherein:
the base of the kettle also provides a “keep warm” switch that, if used before a heating cycle, will cause the device's processor to cooperate with the power supply and heating element to maintain the water in the kettle at a last selected temperature.

36. The device of claim 34, wherein:
the base of the kettle also provides a “keep warm” switch that will cause the device's processor to cooperate with the power supply and heating element to maintain the water in the kettle at a selected temperature for a set period of time.

37. The device of claim 34, wherein:
the base of the kettle also provides a “keep warm” switch that, if used after a heating cycle, will cause the device's processor to cooperate with the power supply and heating element to maintain the water in the kettle at a last selected temperature.

38. The device of claim 28, wherein:
each discrete temperature selection control switch being associated with an illuminated indicator that indicates that a switch has been selected.

39. The device of claim 29, wherein:
a subsequent user selection of the on-off switch during a heating cycle will cause the cycle to be terminated.

40. The device of claim 29, wherein:
the base of the kettle also provides a “keep warm” switch that, if used during a heating cycle, will cause the device's processor to cooperate with the power supply and heating element to maintain the water in the kettle at a last selected temperature.

41. The device of claim 29, wherein:
an indicator associated with the on-off switch changes color so that it is a different color during a heating cycle than at any other time, thus providing feedback regarding which button to press when a cancellation of a cycle is required.

42. The device of claim 29, wherein:
the microprocessor will default to a last temperature selected, the last selected temperature being indicated by the illumination of the indicator, that indicator flashing to indicate that the kettle is in a heating cycle and when a selected temperature is reached, the indicator is illuminated continuously.

43. The device of claim 27, wherein:
each discrete temperature selection control switch has an illuminated indicator that indicates that a switch has been selected by a user;
the base of the kettle providing a “keep warm” switch with a “keep warm” switch indicator that, if used during a heating cycle, will cause the device's processor to cooperate with the power supply and heating element to maintain the contents at a last selected temperature.

44. The device of claim 43, wherein:
an indicator associated with the on-off switch changes appearance so that it is a different appearance during a heating cycle than at any other time, thus providing feedback regarding which button to press when a cancellation of a cycle is required.

45. The device of claim 43, wherein:
the microprocessor will default to a last temperature selected, the last selected temperature being indicated by the illumination of the indicator, that indicator flashing to indicate that the kettle is in a heating cycle and when a selected temperature is reached, the indicator is illuminated continuously.

46. The device of claim 43, wherein:
the base of the kettle also provides a “keep warm” switch that, if used before a heating cycle, will cause the device's processor to cooperate with the power supply and heating element to maintain the water in the kettle at a last selected temperature.
